(19) United States
(12) Patent Application Publication
(10) Pub. No.: US 2026/0089439 A1
(43) Pub. Date: Mar. 26, 2026

(54) APPARATUS, SYSTEM, AND METHOD OF DIRECTION-BASED SOUND EVENT INDICATION

(71) Applicant: INTEL CORPORATION, SANTA CLARA, CA (US)

(72) Inventors: Anna Barnov, Tel Mond (IL); Gila Kamhi, Zichron Yaakov (IL); Oren Haggai, Kfar Sava (IL); Ofir Degani, Nes-Ammin (IL)

(73) Assignee: INTEL CORPORATION, SANTA CLARA, CA (US)

(21) Appl. No.: 18/898,522

(22) Filed: Sep. 26, 2024

(51) Int. Cl. H04R 1/40; H04R 29/00

(52) U.S. Cl. CPC H04R 1/406; H04R 1/403; H04R 29/005; H04R 2420/07; H04R 2430/20

(57) ABSTRACT

For example, a computing device may be configured to process sound information received from an audio device of a user to identify first ambient sound information and second ambient sound information corresponding to a detected sound event in an environment of the audio device, and to determine direction-based information based on the first ambient sound information and the second ambient sound information. For example, the direction-based information may be based on a direction of a source of the sound event relative to a head of the user. For example, the computing device may be configured to trigger a sound event indication to be provided to the user. For example, the sound event indication may be based on the direction-based information.

### BACKGROUND

A computing device may be connected to and/or paired with an audio device, for example, to stream audio content to the audio device.

For example, the computing device and the audio device may utilize a Bluetooth (BT) link, e.g., a BT audio link to stream the audio content from the computing device to the audio device.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a scenario of determining direction-based information corresponding to a sound event, in accordance with some demonstrative aspects.

FIG. 3 is a schematic illustration of a system including a computing device configured to determine direction-based information corresponding to a sound event for a user of an audio device, in accordance with some demonstrative aspects.

FIG. 4 is a schematic illustration of a plurality of head positions, which may be utilized to determine a user-calibrated Head-Related Transfer Function (HRTF), in accordance with some demonstrative aspects.

FIG. 5 is a schematic illustration of a direction-based sound event indication scheme, in accordance with some demonstrative aspects.

FIG. 6 is a schematic illustration of a system including a computing device and an earbud of an audio device, in accordance with some demonstrative aspects.

FIG. 7 is a schematic flow-chart illustration of a method of direction-based sound event indication, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Bluetooth (BT) device, a Bluetooth Low Energy (BLE) device, an audio device, a video device, an audio (A/V) device, a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing Bluetooth standards (“the Bluetooth standards”), e.g., including the Bluetooth Core Specification (Bluetooth Core Specification V 5.3, Jul. 13, 2021) and/or future versions and/or derivatives thereof, devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December 2020)) and/or future versions and/or derivatives thereof, devices and/or networks operating in accordance with existing cellular specifications and/or protocols, units and/or devices which are part of the above networks, and the like.

Some aspects may be used in conjunction with one way and/or two-way radio communication systems, a Bluetooth system, a BLE system, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), Extended GPRS, Code-Division Multiple Access (CDMA), Wideband CDMA (WCDMA), CDMA 2000, single-carrier CDMA, multi-carrier CDMA, Multi-Carrier Modulation (MCM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G), or Sixth Generation (6G) mobile networks, 3GPP, Long Term Evolution (LTE), LTE Advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that is integrated with a computer, or a peripheral that is attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage among others, or any combination thereof. Registers, shift registers, processor registers, data buffers, among others, are also embraced herein by the term memory. The term “software” may be used to refer to any type of executable instruction and/or logic, including firmware, which may be stored, for example, by a memory.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a frequency band of 2.4 GHz, 5 GHz, or 6 GHz. However, other aspects may be implemented utilizing any other suitable wireless communication frequency bands, for example, an Extremely High Frequency (EHF) band (the millimeter wave (mmWave) frequency band), e.g., a frequency band within the frequency band of between 20 GHz and 300 GHz, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Some demonstrative aspects are described herein with respect to BT communication, e.g., according to a BT protocol and/or a BLE protocol. However, other aspects may be implemented with respect to any other communication scheme, network, standard and/or protocol.

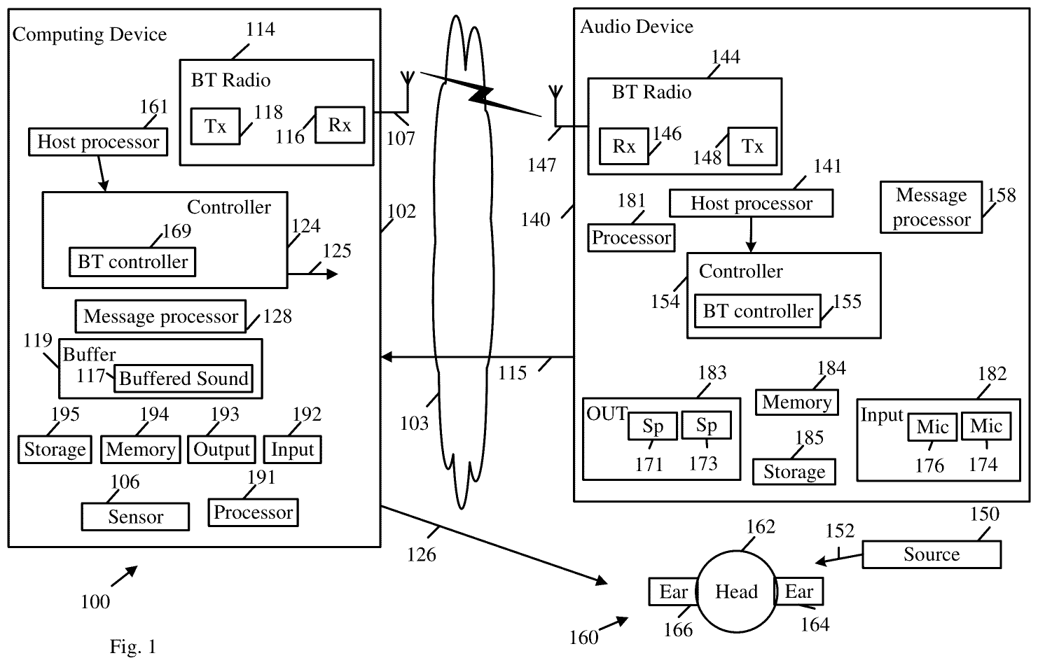

Reference is now made to FIG. 1, which schematically illustrates a block diagram of a system 100, in accordance with some demonstrative aspects.

As shown in FIG. 1, in some demonstrative aspects system 100 may include a wireless communication network including one or more wireless communication devices, e.g., including wireless communication devices 102 and/or 140.

In some demonstrative aspects, device 102 may include a computing device, e.g., as described below.

In some demonstrative aspects, device 102 may include, for example, a UE, an MD, a STA, a PC, a desktop computer, a mobile computer, a laptop computer, an Ultrabook™ computer, a notebook computer, a tablet computer, a server computer, a handheld computer, a Smartphone, a mobile phone, a cellular telephone, a Human Interface Device (HID), a sensor device, a handheld device, a wearable device, an on-board device, an off-board device, a hybrid device, a consumer device, a vehicular device, a non-vehicular device, a mobile or portable device, a non-mobile or non-portable device, a video device, an audio device, an A/V device, a media player, a television, a music player, or the like.

In some demonstrative aspects, device 140 may include an audio device, e.g., as described below.

In some demonstrative aspects, device 140 may include earbuds, e.g., as described below.

In some demonstrative aspects, device 140 may include earphones, e.g., as described below.

In some demonstrative aspects, device 140 may include headphones, e.g., as described below.

In other aspects, device 140 may include any other type of audio device.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of device 102 and/or device 140 may be enclosed in a common housing or packaging, and may be interconnected or operably associated using one or more wired or wireless links. In other aspects, components of device 102 and/or device 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an OS of device 140 and/or of one or more suitable applications.

In some demonstrative aspects, input unit 192 may include, for example, a keyboard, a keypad, a mouse, a touch-screen, a touch-pad, a microphone, or other suitable pointing device or input device. Output unit 193 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, input unit 182 may include, for example, one or more microphones. For example, input unit 182 may include a first microphone 174 corresponding to a first ear 164 of a user 160, e.g., a right ear of the user 160; and/or a second microphone 177 corresponding to a second ear 166 of the user 160, e.g., a left ear of the user 160.

In some demonstrative aspects, output unit 183 may include, for example, one or more audio speakers. For example, output unit 183 may include a first audio speaker 171 corresponding to the first ear 164 of the user 160, e.g., the right ear of the user 160; and/or a second audio speaker 173 corresponding to the second ear 166 of the user 160, e.g., the left ear of the user 160.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (WM) 103.

In some demonstrative aspects, wireless medium 103 may include, for example, a BT channel, a radio channel, a cellular channel, a Global Navigation Satellite System (GNSS) Channel, an RF channel, a WiFi channel, an IR channel, or the like.

In some demonstrative aspects, wireless communication medium 103 may include a 2.4 GHz frequency band, and/or one or more other wireless communication frequency bands, for example, a 5 GHz frequency band, a 6 GHz frequency band, a millimeterWave (mmWave) frequency band, e.g., a 60 GHz frequency band, a Sub-1 GHz (S1G) band, and/or any other frequency band.

In some demonstrative aspects, devices 102 and/or 140 may include, operate as, and/or perform the functionality of one or more BT devices.

In some demonstrative aspects, devices 102 and/or 140 may include a BT mobile device. In other aspects, devices 102 and/or 140 may include a non-mobile BT device.

In one example, devices 102 and/or 140 may include BT Low Energy (LE) (BLE) compatible devices. In other aspects, devices 102 and/or 140 may include or implement any other additional or alternative BT communication functionality, e.g., according to any other additional or alternative BT protocol.

In some demonstrative aspects, device 140 may include, operate as, and/or perform the functionality of, a BT audio device. For example, the BT audio device may include a BT headset, a BT headphone(s), a BT earphone(s), BT earbuds, a BT hands-free device, a voice-controlled device, a smart speaker device, a sensor device, a BT A/V device, a device incorporating a BT audio device, and/or any other audio device, which may be configured to communicate audio traffic with BT device 102, e.g., as described below.

In some demonstrative aspects, device 140 may include, operate as, and/or perform the functionality of a BT audio sink device. For example, BT audio sink device 140 may include a headset, earbuds, earphones, headphones, a hearing aid, and/or any other device configured to output audio to a user of the BT audio sink device 140.

In some demonstrative aspects, device 102 may include, operate as, and/or perform the functionality of a BT audio source device. For example, BT audio source device 102 may be configured as BT audio source device, which may transmit audio streams via BT communication, e.g., as described below.

In some demonstrative aspects, devices 102 and/or 140 may include one or more BT radios including circuitry and/or logic to perform wireless communication between devices 102, 140 and/or one or more other BT devices. For example, device 102 may include at least one BT radio 114, and/or device 140 may include at least one BT radio 144.

In some demonstrative aspects, devices 102 and/or 140 may include one or more other radios, e.g., a WiFi radio, an OFDM radio, a cellular radio, and/or the like.

In some demonstrative aspects, BT radio 114 and/or BT radio 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative aspects, BT radio 114 and/or BT radio 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative aspects, BT radio 114, BT radio 144, transmitter 118, transmitter 148, receiver 116, and/or receiver 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, BT radio 114 and/or BT radio 144 may be configured to communicate over a 2.4 GHz band, and/or any other band.

In some demonstrative aspects, BT radio 114 and/or BT radio 144 may include, or may be associated with, one or more antennas. For example, BT radio 114 may include, or may be associated with, one or more antennas 107; and/or BT radio 144 may include, or may be associated with, one or more antennas 147.

In one example, device 102 may include a single antenna 107. In another example, device 102 may include two or more antennas 107.

In one example, device 140 may include a single antenna 147. In another example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controller 124 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controller 124. Additionally or alternatively, one or more functionalities of controller 124 may be implemented by logic, which may be executed by a machine and/or one or more processors, e.g., as described below.

In one example, controller 124 may include circuitry and/or logic, for example, one or more processors including circuitry and/or logic, to cause, trigger and/or control a BT audio device, e.g., device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, controller 124 may be configured to include and/or perform one or more functionalities and/or operations of a BT controller 169 of the BT device 102.

In some demonstrative aspects, one or more functionalities and/or operations of controller 124 may be implemented as part of a host processor 161 of the BT device 102.

In other aspects, controller 124 may be implemented by one or more additional or alternative elements of device 102.

In some demonstrative aspects, controller 154 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of controller 154. Additionally or alternatively, one or more functionalities of controller 154 may be implemented by logic, which may be executed by a machine and/or one or more processors, e.g., as described below.

In one example, controller 154 may include circuitry and/or logic, for example, one or more processors including circuitry and/or logic, to cause, trigger and/or control a BT audio device, e.g., device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, controller 154 may be configured to include and/or perform one or more functionalities and/or operations of a BT controller 155 of the BT device 140.

In some demonstrative aspects, one or more functionalities and/or operations of controller 154 may be implemented as part of a host processor 141 of the BT device 140.

In other aspects, controller 154 may be implemented by one or more additional or alternative elements of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include circuitry and/or logic, e.g., processor circuitry and/or logic, memory circuitry and/or logic, MAC circuitry and/or logic, PHY circuitry and/or logic, and/or any other circuitry and/or logic, configured to perform the functionality of message processors 128 and/or 158. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of BT radio 114. For example, the chip or SoC may include one or more elements of controller 124, one or more elements of message processor 128, and/or one or more elements of BT radio 114. In one example, controller 124, message processor 128, and BT radio 114 may be implemented as part of the chip or SoC.

In other aspects, controller 124, message processor 128 and/or BT radio 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of BT radio 144. For example, the chip or SoC may include one or more elements of controller 154, one or more elements of message processor 158, and/or one or more elements of BT radio 144. In one example, controller 154, message processor 158, and BT radio 144 may be implemented as part of the chip or SoC.

In other aspects, controller 154, message processor 158 and/or BT radio 144 may be implemented by one or more additional or alternative elements of device 140.

In some demonstrative aspects, device 102 and/or device 140 may be configured to implement one or more functionalities and/or operations according to a wireless audio streaming technology, for example, a Low Energy (LE) audio technology, e.g., as described below.

In some demonstrative aspects, device 102 and/or device 140 may be configured to implement one or more functionalities and/or operations according to the LE audio technology, for example, to provide a technical solution to support multi stream capabilities, for example, for a standardized approach, e.g., as described below.

In some demonstrative aspects, the multi stream capabilities may provide a technical solution to support a source audio device to stream very high synchronized audio streams to one or more sink devices, and/or to one or more coordinated device sets, e.g., as described below.

In some demonstrative aspects, device 102 and/or device 140 may be configured to implement one or more functionalities and/or operations according to the LE audio technology, for example, to provide a technical solution to support wireless, e.g., truly wireless, earbuds, earphones, headphones, for example, including hearing aids devices, e.g., as described below.

In some demonstrative aspects, device 102 and/or device 140 may be configured to implement one or more functionalities and/or operations according to the LE audio technology, for example, to provide a technical solution to support lower power consumption of a hearable device for various applications, e.g., as described below.

For example, left and right earbuds may utilize the LE audio technology to run for a longer time on their batteries, for example, due to an efficient use of individual left stream and right stream, and/or lower duty cycle.

In one example, a user, e.g., user 160, may wear LE Audio hearables, e.g., earbuds, hearing aids or the like, for example, to listen to content from computing device 102, for example, for long durations during the day.

For example, LE audio users may have more listen time opportunities, and therefore, may be less attentive to their surroundings. For example, LE audio users may use an audio device to listen to music, online learning classes, a nearby TV, conference calls, and/or the like, which may cause the users to be less attentive to their surroundings and/or to one or more ambient sound events in their surroundings.

In one example, the one or more ambient sound events may include, for example, a sound event, e.g., a scream, a knock on the door, a ringtone, and/or the like.

In another example, the one or more ambient sound events may include, for example, a spoken term event, e.g., another person calling the user's name, saying excuse me, hey, and/or the like.

For example, the user may be listening to audio from the computing device 102, e.g., the user may be disconnected from the environment ambient audio, and may miss the opportunity to respond to its surroundings, for example, when one or more ambient audio events occur.

In some demonstrative aspects, device 102 and/or device 140 may be configured to implement one or more functionalities and/or operations according to a direction-based sound event indication mechanism, which may be configured to provide a technical solution to support a direction-based indication of one or more sound events, e.g., as described below.

In some demonstrative aspects, the direction-based sound event indication mechanism may be configured to provide a technical solution to support detection of one or more ambient sounds in an environment of the user 160, e.g., as described below.

In some demonstrative aspects, device 102 and/or device 140 may be configured to implement one or more functionalities and/or operations of a direction-based sound event indication mechanism, which may be configured to provide a technical solution to support identifying an origin of a detected sound event, e.g., as described below. For example, the origin of the detected sound event may include a point source originating a sound signal.

In some demonstrative aspects, the detected sound event may include a Sound Event Detection (SED), for example, of a specific sound, e.g., a scream, a knock on the door, or the like.

In some demonstrative aspects, the detected sound event may include a Spoken Term Detection (STD), for example, of a pre-defined spoken term, e.g., an approach to the user, “excuse me”, a spoken name of the user 160, and/or the like.

In some demonstrative aspects, device 102 and/or device 140 may be configured to implement one or more functionalities and/or operations of a direction-based sound event indication mechanism, which may be configured to provide a technical solution to support improved identification of an origin of a detected sound event, which may include, for example, identification of location information of the detected sound event relative to a position of the user 160, for example, relative to a head 162 of the user 160, e.g., as described below.

In some demonstrative aspects, the location information may be based, for example, on a Direction of Arrival (DoA) estimation. For example, the DoA estimation may estimate a DoA of a sound signal of the detected sound event, e.g., as described below.

In some demonstrative aspects, device 102 and/or device 140 may be configured to implement one or more functionalities and/or operations of a direction-based sound event indication mechanism, which may be configured to provide a technical solution to support providing a visual indication of the detected sound event to the user 160, for example, on a screen of computing device 102, e.g., as described below.

In some demonstrative aspects, device 102 and/or device 140 may be configured to implement one or more functionalities and/or operations of a direction-based sound event indication mechanism, which may be configured to provide a technical solution to support providing an audio indication of the detected sound event to the user 160, for example, at an ear position relative to the sound directionality, or as a stereo rendered spatial signal, e.g., as described below.

In some demonstrative aspects, device 102 and/or device 140 may be configured to implement one or more functionalities and/or operations of a direction-based sound event indication mechanism, which may be configured to provide a technical solution to support a power efficient scheme for detection of a DoA of a detected sound event, for example, as part of a complex audio system, which may combine SED events and/or STD events and a Bluetooth LE (BLE) connected hearable device, for example, device 140, e.g., as described below.

In some demonstrative aspects, device 102 and/or device 140 may be configured to implement one or more functionalities and/or operations of a direction-based sound event indication mechanism, which may be configured to provide a technical solution to support adoption of a hearable device as an audio source, for example, to stream ambient sounds captured by microphones of the hearable device, for example, over a Basic Audio Profile (BAP), e.g., as described below.

For example, device 102 and/or device 140 may be configured to implement one or more functionalities and/or operations of a direction-based sound event indication mechanism, which may be configured to provide a technical solution to support adoption of device 140 as an audio source, for example, to stream ambient sounds captured by the audio device 140, e.g., by microphone 173 and/or microphone 171, for example, over a BAP or any other suitable profile and/or link, e.g., as described below.

In some demonstrative aspects, device 102 and/or device 140 may be configured to implement one or more functionalities and/or operations of a direction-based sound event indication mechanism, which may be configured to provide a technical solution to support implementation of a DoA estimator algorithm, for example, in compliance with given efficiency constraints, e.g., as described below.

In some demonstrative aspects, device 102 and/or device 140 may be configured to implement one or more functionalities and/or operations of a direction-based sound event indication mechanism, which may be configured to provide a technical solution to support a spatial audio generation scheme, for example, to provide spatial audio configured to notify the user 160 of a DoA of a source 150 of a sound event 152, e.g., as described below.

In some demonstrative aspects, device 102 and/or device 140 may be configured to implement one or more functionalities and/or operations of a direction-based sound event indication mechanism, which may be configured to provide a technical solution to support a binaural capturing of ambient sounds from microphones of device 140, e.g., microphone 173 and/or microphone 171, for example, by device 102, e.g., a connected PC device, which may scale the LE Audio technology to support this capability, for example, for ambient sound DoA, e.g., as described below.

In some demonstrative aspects, device 102 and/or device 140 may be configured to implement one or more functionalities and/or operations of a direction-based sound event indication mechanism, which may be configured to provide a technical solution to support hearable devices, e.g., hearing aid devices, at which power preservation and usability may play important role in daily activities, e.g., as described below.

In some demonstrative aspects, device 102 and/or device 140 may be configured to implement one or more functionalities and/or operations of a direction-based sound event indication mechanism, which may be configured to provide a technical solution to support detection of a direction, e.g., an origin, of an ambient sound of interest, for example, while a user is listening via an audio device, e.g., device 140, e.g., a Bluetooth hearable device, to audio content, which may be streamed from another device, e.g., device 102, for example, when the user may be unaware of the surrounding environment, e.g., as described below.

In some demonstrative aspects, device 102 and/or device 140 may be configured to implement one or more functionalities and/or operations of a direction-based sound event indication mechanism, which may be configured to provide a technical solution to support providing the user with a directional indication of a detected ambient sound, for example, via LE audio, and/or via a visual indication, e.g., via computing device 102, e.g., as described below.

In some demonstrative aspects, device 102 and/or device 140 may be configured to implement one or more functionalities and/or operations of a direction-based sound event indication mechanism, which may be configured to provide a technical solution to support one or more productivity use cases and/or PC usability, for example, to allow users with LE Audio hearables to be more responsive to their surroundings, while still focusing on their work with the audio stream, e.g., as described below.

In some demonstrative aspects, device 102 and/or device 140 may be configured to implement one or more functionalities and/or operations of a direction-based sound event indication mechanism, which may be configured to provide a technical solution to support configuration of left and right audio streams from device 102 towards device 140, for example, to reduce power consumption of device 140, e.g., as described below.

In some demonstrative aspects, device 102 and/or device 140 may be configured to implement one or more functionalities and/or operations of a direction-based sound event indication mechanism, which may be configured to provide a technical solution to support detection of sound directionality for people with hearing loss, which may have more difficulties to detect the sound directionality, for example, as they may rely on their hearing aids to amplify the frequency content and, therefore, masking an ability of the brain to detect sound directionality, e.g., as described below.

For example, device 102 and/or device 140 may be configured to implement one or more functionalities and/or operations according to a direction-based sound event indication mechanism, which may be configured to provide a technical solution to support a sound direction guidance to improve a quality of life of users of hearing aids, e.g., as described below.

In some demonstrative aspects, there may be one or more technical problems, disadvantages, and/or inefficiencies in some implementations, which may be configured to compute sound directionality on a hearable device, e.g., as described below.

In one example, computation of a DoA of an ambient sound on a hearable device may require high compute power, which may not be acceptable, for example, considering battery life of the hearable device.

In another example, computation of a DoA of an ambient sound on a hearable device may require implementation of Artificial Intelligence (AI) compute resources in the hearable device, which may be limited, e.g., compared to AI resources on a computing device, e.g., a PC.

In some demonstrative aspects, there may be one or more technical problems, disadvantages, and/or inefficiencies in some implementations, which may be configured to detect sound directionality based only on microphones of a computing device, e.g., as described below.

In one example, determining a DoA of an ambient sound, e.g., as perceived by the user, based only on the microphones of the computing device may be complex, for example, with respect to many real life applications for which the user may not be positioned in front of the computing device.

In some demonstrative aspects, device 102 and/or device 140 may be configured to implement one or more functionalities and/or operations of a direction-based sound event indication mechanism, which may be configured to provide a technical solution to support providing a spatial-sound indication to indicate to the user a directionally of an ambient sound, e.g., as described below.

In some demonstrative aspects, there may be one or more technical problems, disadvantages, and/or inefficiencies in some implementations of gaming applications, which utilize spatial audio for spatial-sound indication, e.g., as described below.

In one example, spatial audio generation may require high computation power, which may not be feasible for standard PCs to be done continuously.

In some demonstrative aspects, there may be one or more technical problems, disadvantages, and/or inefficiencies in some implementations of Virtual Reality (VR) applications, which utilize spatial audio for spatial-sound indication, e.g., as described below.

In one example, the VR applications may require dedicated hardware, e.g., an Inertial Measurement Unit (IMU), for example, to track head movement in real time, which may not be available in audio devices. For example, earbuds, including hearing aid devices, may not include this kind of hardware.

In some demonstrative aspects, device 102 and/or device 140 may be configured to implement one or more functionalities and/or operations of a direction-based sound event indication mechanism, which may be configured to provide a technical solution to support an implementation of computing device 102 for detection of sound directionality of an ambient sound, and providing to a user a spatial-sound indication to indicate the directionally of the ambient sound, for example, while meeting compute, power, and/or hardware constraints, e.g., as described below.

In some demonstrative aspects, controller 124 and/or BT controller 169 may be configured to control, trigger, cause, and/or instruct computing device 102 to process sound information 115 received from audio device 140 of the user 160, for example, to identify first ambient sound information and second ambient sound information corresponding to a detected sound event 152 in an environment of the audio device 140, e.g., as described below.

In some demonstrative aspects, the first ambient sound information may be based, for example, on first ambient sound sensed by the audio device 140 corresponding to the first ear 164 of the user 160, e.g., as described below.

In one example, the first ambient sound information may be based, for example, on first ambient sound sensed by the microphone 174, which corresponds to the first ear 164 of the user 160.

In some demonstrative aspects, the second ambient sound information may be based, for example, on second ambient sound sensed by the audio device 140 corresponding to the second ear of the user 160, e.g., as described below.

In one example, the second ambient sound information may be based, for example, on second ambient sound sensed by the microphone 176, which corresponds to the second ear 166 of the user 160.

In some demonstrative aspects, controller 124 and/or BT controller 169 may be configured to control, trigger, cause, and/or instruct computing device 102 to determine direction-based information 125, for example, based on the first ambient sound information and the second ambient sound information, e.g., as described below.

In some demonstrative aspects, the direction-based information 125 may be based, for example, on a direction of a source 150 of the sound event 152 relative to the head 162 of the user 160, e.g., as described below.

In some demonstrative aspects, controller 124 and/or BT controller 169 may be configured to control, trigger, cause, and/or instruct computing device 102 to trigger a sound event indication 126 to be provided to the user 160, e.g., as described below.

In some demonstrative aspects, the sound event indication 126, may be based, for example, on the direction-based information 125, e.g., as described below.

In some demonstrative aspects, controller 124 and/or BT controller 169 may be configured to control, trigger, cause, and/or instruct computing device 102 to trigger the sound event indication 126, for example, by triggering an audio indication to be provided by the audio device 140 to the user 160, e.g., as described below.

In some demonstrative aspects, controller 124 and/or BT controller 169 may be configured to control, trigger, cause, and/or instruct computing device 102 to trigger the sound event indication 126, for example, by triggering a binaural audio indication to be provided by the audio device 140 to the user 160, e.g., as described below.

In some demonstrative aspects, the binaural audio indication nay be configured, for example, based on the direction-based information 125, e.g., as described below.

In some demonstrative aspects, controller 124 and/or BT controller 169 may be configured to control, trigger, cause, and/or instruct computing device 102 to configure the binaural audio indication to include first processed audio to be provided to the first ear 164 of the user 160, and second processed audio to be provided to the second ear 166 of the user 160, e.g., as described below.

In some demonstrative aspects, controller 124 and/or BT controller 169 may be configured to control, trigger, cause, and/or instruct computing device 102 to configure the first processed audio based, for example, on the first ambient sound information and the direction-based information 125, e.g., as described below.

In some demonstrative aspects, controller 124 and/or BT controller 169 may be configured to control, trigger, cause, and/or instruct computing device 102 to configure the second processed audio based, for example, on the second ambient sound information and the direction-based information 125, e.g., as described below.

In some demonstrative aspects, the sound event indication 126 may include a visual indication to be displayed to the user 160, for example, by a display of the computing device 102, e.g., as described below.

In other aspects, the sound event indication 126 may include any other type of indication to be provided to the user 160.

In some demonstrative aspects, the sound event 152 may include a predefined spoken term, e.g., as described below.

In some demonstrative aspects, the sound event 152 may include a user-defined event, which may be defined for the user 160, e.g., as described below.

In other aspects, the sound event 152 may include any other additional and/or alternative sound, audio, voice, noise, and/or the like.

In some demonstrative aspects, controller 124 and/or BT controller 169 may be configured to control, trigger, cause, and/or instruct computing device 102 to configure a Bluetooth LE Basic Audio Profile (BAP), which may be configured, for example, to communicate the sound information 115 from a BAP audio source, e.g., including the audio device 140, to a BAP audio sink, e.g., including the computing device 102, e.g., as described below.

In some demonstrative aspects, controller 124 and/or BT controller 169 may be configured to control, trigger, cause, and/or instruct computing device 102 to detect the sound event 152, for example, during an audio streaming of audio content to the audio device 140, e.g., as described below.

In some demonstrative aspects, controller 124 and/or BT controller 169 may be configured to control, trigger, cause, and/or instruct computing device 102 to detect the sound event 152, for example, during an audio streaming of audio content from the computing device 102 to the audio device 140, e.g., as described below.

In some demonstrative aspects, device 102 may stream the audio streaming of audio content to the audio device 140, e.g., as described below.

In some demonstrative aspects, the audio streaming of the audio content may include Bluetooth LE audio streaming of the audio content from the computing device 102 to the audio device 140, e.g., as described below.

In some demonstrative aspects, another device, e.g., a smartphone or any other computing device, may stream the audio streaming of audio content to the audio device 140.

In some demonstrative aspects, controller 124 and/or BT controller 169 may be configured to control, trigger, cause, and/or instruct computing device 102 to trigger the sound event indication 126, for example, during the audio streaming of the audio to the audio device 140, e.g., as described below.

In some demonstrative aspects, controller 124 and/or BT controller 169 may be configured to control, trigger, cause, and/or instruct computing device 102 to send to the audio device 140 a request to provide the first ambient sound information based on a first output from a first ambient microphone of the audio device 140, e.g., microphone 171, and/or to provide the second ambient sound information based on a second output from a second ambient microphone of the audio device 140, e.g., microphone 173, e.g., as described below.

In some demonstrative aspects, controller 124 and/or BT controller 169 may be configured to control, trigger, cause, and/or instruct computing device 102 to detect the sound event 152, for example, based on the sound information received from the audio device 140, e.g., as described below.

In some demonstrative aspects, controller 124 and/or BT controller 169 may be configured to control, trigger, cause, and/or instruct computing device 102 to detect the sound event 152, for example, based on acoustic information from at least one acoustic sensor 106 of the computing device 102, e.g., as described below.

In some demonstrative aspects, controller 124 and/or BT controller 169 may be configured to control, trigger, cause, and/or instruct computing device 102 to maintain buffered sound information 117, for example, by buffering the sound information 115 in a suitable buffer 119, e.g., as described below. In one example, buffer 119 may include a buffer, e.g., a dedicated buffer, implemented by controller 124. In another example, buffer 119 may be implemented by memory 194 and/or by any other element of device 102.

In some demonstrative aspects, controller 124 and/or BT controller 169 may be configured to control, trigger, cause, and/or instruct computing device 102 to trigger processing of the buffered sound information 117, for example, to determine the direction-based information 125, for example, based on detection of the sound event 152, e.g., as described below.

In some demonstrative aspects, controller 124 and/or BT controller 169 may be configured to determine the direction-based information 125 to include Relative Transfer Function (RTF) information corresponding to an RTF between a first channel and a second channel, e.g., as described below.

In some demonstrative aspects, the first channel may include a channel between the first ear 164 and the source 150 of the sound event 152, e.g., as described below.

In some demonstrative aspects, the second channel may include a channel between the second ear 166 and the source 150 of the sound event 152, e.g., as described below.

In some demonstrative aspects, controller 124 and/or BT controller 169 may be configured to determine the direction-based information 125 to include Direction of Arrival (DoA) information of an estimated DoA of the sound event 152, for example, relative to the head 162 of the user 160, e.g., as described below.

In some demonstrative aspects, controller 124 and/or BT controller 169 may be configured to control, trigger, cause, and/or instruct computing device 102 to determine the DoA information, for example, based on a predefined Head-Related Transfer Function (HRTF), e.g., as described below.

In some demonstrative aspects, controller 124 and/or BT controller 169 may be configured to control, trigger, cause, and/or instruct computing device 102 to determine the DoA information, for example, based on a user-calibrated HRTF corresponding to the user 160, e.g., as described below.

In some demonstrative aspects, controller 124 and/or BT controller 169 may be configured to control, trigger, cause, and/or instruct computing device 102 to instruct the user 160 to position the head 162 of the user 160 at a plurality of different head positions during a plurality of calibration time periods, e.g., as described below.

In some demonstrative aspects, controller 124 and/or BT controller 169 may be configured to control, trigger, cause, and/or instruct computing device 102 to emit sound calibration sounds via one or more acoustic transducers of the computing device 102 during the plurality of calibration time periods, e.g., as described below.

In some demonstrative aspects, controller 124 and/or BT controller 169 may be configured to control, trigger, cause, and/or instruct computing device 102 to determine the user calibrated HRTF, for example, based on calibration sound information received from the audio device 140 during the plurality of calibration time periods, e.g., as described below.

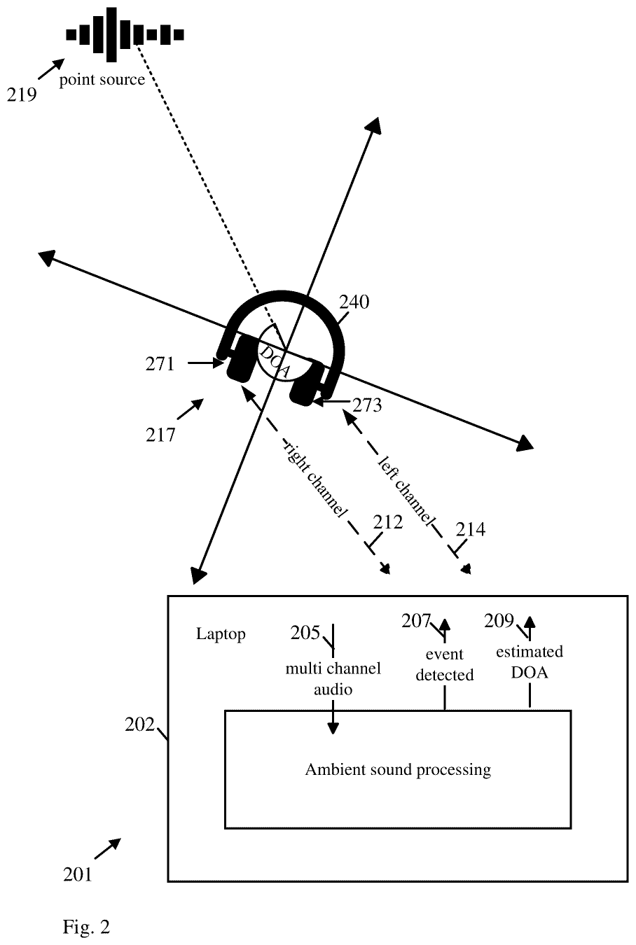

Reference is made to FIG. 2, which schematically illustrates a scenario 201 of determining direction-based information corresponding to a sound event, in accordance with some demonstrative aspects.

In some demonstrative aspects, a computing device 202, e.g., a laptop, may stream audio content to an audio device 240, e.g., headphones or earphones, for example, two LE audio earbuds. For example, computing device 102 (FIG. 1) may include one or more element of computing device 202, and/or may perform one or more operations and/or functionalities of computing device 202.

In some demonstrative aspects, a user of audio device 240 may run productivity tasks on computing device 202, for example, involving audio, such as online learning, conference calls, etc., or listening to music or any other audio, for example, while working on the computing device 202.

In some demonstrative aspects, the computing device 202 may monitor ambient sounds 205, for example, while the computing device 202 is generating audio content to a left-side earbud 273 and to a right-side earbud 271 of audio device 240. For example, the computing device 202 may monitor the ambient sounds 205, for example, via microphones of the computing device 202, and/or based on hearable (ambient) microphones of audio device 240.

In one example, ambient sounds 205 may include a doorbell or a knock at the door.

In another example, ambient sounds 205 may include sound of a phone call.

In another example, ambient sounds 205 may include nearby people speaking, e.g., to the user of audio device 240, or otherwise, and/or any other sounds.

In some demonstrative aspects, when the computing device 202 monitors the ambient sounds 205, the computing device 202 may adaptively filter relevant sounds that may need the user attention.

In some demonstrative aspects, when the computing device 202 detects a relevant sound 207 that needs the user attention, the computing device 202 may trigger a DoA estimation 209, which may be followed by a visual notification and/or a stereo audio notification to the user.

In some demonstrative aspects, the stereo audio notification may be configured to indicate a sound source location 219 relative to a user position 217.

In some demonstrative aspects, audio signals used for the DoA estimation 209 may be captured by ambient microphones of audio device 240.

In some demonstrative aspects, computing device 202 may utilize a PC hear-through mode, in which audio captured by the ambient microphones of audio device 240 may be transmitted to computing device 202 for processing, e.g., via a right channel 212 and a left channel 214 between the audio device 240 and computing device 202.

In some demonstrative aspects, computing device 202 may be configured to “listen” to ambient sounds, e.g., instead of the user, for example, to provide a technical solution to support the user in engaging in a current activity, for example, without distractions, while notifying the user of any ambient meaningful sounds.

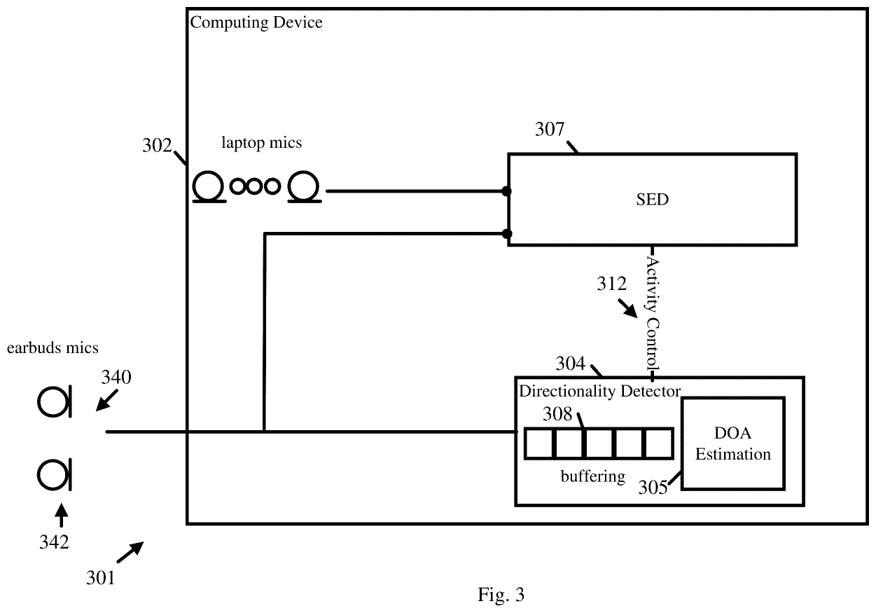

Reference is made to FIG. 3, which schematically illustrates a system 301 including a computing device 302 configured to determine direction-based information corresponding to a sound event for a user of an audio device 340, in accordance with some demonstrative aspects. For example, computing device 102 (FIG. 1) may include one or more element of computing device 302, and/or may perform one or more operations and/or functionalities of computing device 302.

In one example, computing device 302 may include a laptop or any other computing device; and/or audio device 340 may include earbuds including one or more earbud ambient microphones 342.

In some demonstrative aspects, as shown in FIG. 3, computing device 302 may include a directionally detector 304, which may be configured to perform a DoA estimation 305 of ambient sounds detected by the ambient microphones 342.

In some demonstrative aspects, computing device 302 may trigger (312) the directionally detector 304, for example, when a sound event is detected by an SED/STD module 307, which may be in an always-on mode.

In some demonstrative aspects, the selective triggering of the directionally detector 304 based on a sound event detected by SED/STD module 307 may provide a technical solution to reduce power consumption associated with the DoA estimation 305 by directionally detector 304.

In some demonstrative aspects, directionally detector 304 may include a sound buffer 308 for internal buffering of ambient sounds.

In some demonstrative aspects, the internal buffering of ambient sounds may be implemented, for example, to provide a technical solution to compensate for a processing time of the SED module 307, and to estimate the DoA based on time stamps of a detected sound event.

In some demonstrative aspects, computing device 302 may suspend a user indication, for example, until the DoA is estimated, or may add it on top after it is processed.

In some demonstrative aspects, directionally detector 304 may estimate the DoA relative to a user position, e.g., user position 217 (FIG. 2), for example, to support a technical solution in common situations where a user may step away from a computing device, e.g., a PC, while being connected via Bluetooth, or to move his head.

In some demonstrative aspects, computing device 302 may utilize a stereo signal from left and right microphones of audio device 340, for example, to estimate the DoA relative to the user position.

In some demonstrative aspects, an involved latency of the DoA estimation may be assumed to be small enough, for example, to not be perceived by the user, and the location indication may be perceived as triggered in real time.

In some demonstrative aspects, audio device 340 may be configured to operate as a BAP audio source, and computing device 302 may be configured to operate as a BAP audio sink, for example, utilizing an LE multi stream audio capability of audio device 340, for example, to provide a technical solution to preserve compute power for audio device 340, e.g., battery powered earbuds, and/or to leverage a compute power of the computing device 302 for the DoA estimation 305.

In some demonstrative aspects, directionally detector 304 may estimate the DoA based, for example, on audio signals captured by the earbud ambient microphones 342 of audio device 340.

In some demonstrative aspects, directionally detector 304 may estimate the DoA based on audio signals captured by the earbud ambient microphones 342 of audio device 340.

In one example, estimating the DoA based only on microphones of the computing device 302 may introduce a complexity of mapping the user physical location relative to that of the computing device 302, as well as rendering the spatial notification to the user.

In one example, estimating the DoA based on both on microphone sets of the computing device 302 and the earbuds 340 may provide additional information that could potentially be used to improve the DoA estimation, while potentially introducing some degree of system complexity and/or a compute load.

In some demonstrative aspects, computing device 302 may be configured to provide a technical solution to map the user physical location relatively to the location of the computing device 302, as well as rendering the spatial notification to the user, for example, while utilizing the audio signals captured by the earbud ambient microphones 342 of audio device 340.

In some demonstrative aspects, the DoA estimation 305 may be based on an RTF between the right earbud and the left earbud of audio device 340.

In some demonstrative aspects, the RTF may represent the relations between the two channels of a binaural signal, e.g., the right channel 212 (FIG. 2) and the left channel 214 (FIG. 2).

In some demonstrative aspects, computing device 302 may determine the DoA estimation based on the RTF, which may be calibrated, for example, based on calibration data. For example, the calibration data may be utilized in implementations where a geometry of a microphone array is not known.

In some demonstrative aspects, computing device 302 may determine the DoA estimation based, for example, on an HRTF, which may be unique per user.

In some demonstrative aspects, computing device 302 may determine the DoA estimation based, for example, on based on a user-calibrated HRTF corresponding to the user (“user self-calibration”).

In some demonstrative aspects, computing device 302 may instruct a user to calibrate the system 301, for example, to determine an HRTF specific to the user, and to calibrate the DoA estimation module for their specific setup.

In some demonstrative aspects, computing device 302 may include a calibration application, which may control emitting of full band sounds from speakers of computing device 302, which may be captured by the ambient microphones 342 of audio device 340, for example, at different head positions of the user, which may be as guided by the calibration application.

In some demonstrative aspects, computing device 302 may determine an HRTF for a possible head rotation, e.g., for each possible head rotation, for example, based on interpolation of a plurality of head positions.

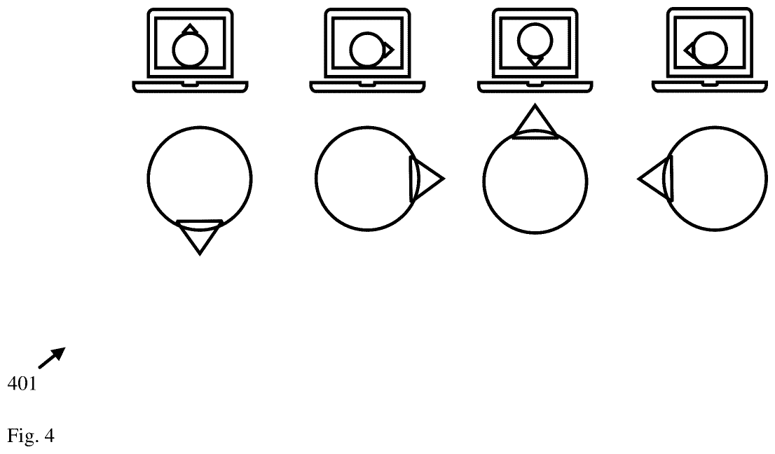

Reference is made to FIG. 4, which schematically illustrates a plurality of head positions 401, which may be utilized to determine a user-calibrated HRTF, in accordance with some demonstrative aspects.

In one example, a User Interface (UI) of a calibration application, e.g., implemented by computing device 102 (FIG. 1), may instruct a user to position her head at one or more, e.g., some or all, of the plurality of head positions 401, which may be used to calibrate the HRTF for the user.

Referring back to FIG. 3, in some demonstrative aspects, computing device 302 may determine the DoA based on a predefined HRTF (“no user calibration”).

In some demonstrative aspects, the predefined HRTF may be based, for example, on database records of recorded HRTFs and Binaural Room Impulse Responses.

In some demonstrative aspects, the estimated DoA based on the predefined HRTF may have reduced accuracy, e.g., compared to the DoA estimated based on the user-calibrated HRTF.

In some demonstrative aspects, computing device 302 may determine the DoA based on the database records, for example, utilizing one or more suitable similarity measures.

In some demonstrative aspects, an accuracy of the DoA estimation based on the predefined HRTF may be improved, for example, when utilizing an array of calibrated microphones. For example, internal microphones of the computing device 302 may be configured as the array of calibrated microphones.

In one example, calibration of the array of microphones may be performed in a lab for different PC models, and hence may provide a technical solution for a predefined HRTS, which may require substantially no calibration by the user and/or a manufacturer.

In some demonstrative aspects, accuracy of the DoA estimation based on the predefined HRTF may be improved, for example, based on one or more Neural Network (NN) pre trained models, which may support detection of multiple audio sources, e.g., without the need for calibration.

In some demonstrative aspects, computing device 302 may be configured to determine the DoA estimation, for example, even without explicitly determining the DoA (“No explicit DoA estimation”).

For example, explicit estimation of the DoA angle may not be required in an implementation where the DoA notification is provided to the user via an emitted spatial signal from the computing device 302 to the user over stereo LE audio.

In some demonstrative aspects, computing device 302 may use the estimated RTF, during a time period where a sound event was detected, e.g., for modulating the audio que for the audio DoA notification to the user.

In some demonstrative aspects, the user self-calibration mechanism, the no user calibration mechanism, and/or the no explicit DoA estimation mechanism described above may have one or more different properties and/or advantages, for example, with respect to various use cases, e.g., as follows:

TABLE (1)

| | User | DoA (angle) | DoA (angle) | Spatial |
|---|---|---|---|---|
| | calibration | is | estimation | rendering |
| | required | estimated | accuracy | supported |
| User self | yes | yes | high | yes |
| calibration | | | | |
| No user | no | yes | mid | yes |
| calibration | | | | |
| No explicit | no | no | n/a | yes |
| DoA estimation | | | | |

In some demonstrative aspects, computing device 302 may be configured to provide a binaural audio indication, which may be configured according to a binaural human hearing system.

In some demonstrative aspects, the HRTF may be a key concept in binaural hearing, for example, as the HRTF may produce the sound difference between the ears.

In one example, only level and time difference between two audio channels may be considered to perceive direction, e.g., in traditional stereo audio. However, when considering timbral differences of the ears, a more intricate spatial sound experience may be created. Accordingly, many real time applications for binaural audio rendering may require an HRTF estimate.

In some demonstrative aspects, a more accurate source position may be perceived by the user, for example, as a more precise the HRTF estimate is used per human. However, the HRTF may be unknown and time varying, for example, for most real-life applications. Accordingly, in some cases additional sensors, such as visual sensors, may be required for an accurate HRTF estimation.

In some demonstrative aspects, system 301 may be implemented to provide a technical solution to support precise estimation of the HRTF, and to modulate any desired audio que in real time towards the user, for example, by using the audio captured by audio device 340, e.g., via a BT hearable including hearing aids.

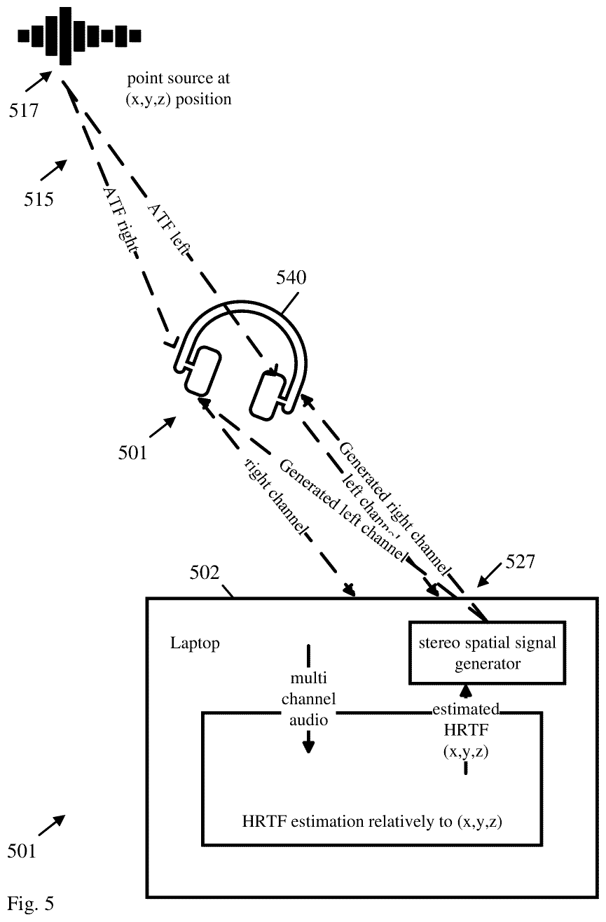

Reference is made to FIG. 5, which schematically illustrates a direction-based sound event indication scheme 501, in accordance with some demonstrative aspects.

In some demonstrative aspects, as shown in FIG. 5, a signal 515 from a source 517 received by microphones of an audio device 540, may be characterized by right and left Acoustic Transfer Functions (ATFs).

In some demonstrative aspects, as shown in FIG. 5, the source 517 of the signal 515 may be at a particular (x,y,z) position.

In some demonstrative aspects, a computing device 502 may estimate the ATFs of the signal 515, and may compute an HRTF based on the ATFs. For example, computing device 102 (FIG. 1) may include one or more elements of computing device 502, and/or may perform one or more operations and/or functionalities of computing device 502.

In some demonstrative aspects, computing device 502 may convolve a desired audio que with the HRTF, for example, to produce a directional notification 527, which may be transmitted to the left and right earbuds of audio device 540.

For example, a user of audio device 540 may perceive the audio que as if it is coming from the direction (x,y,z) of the source 517.

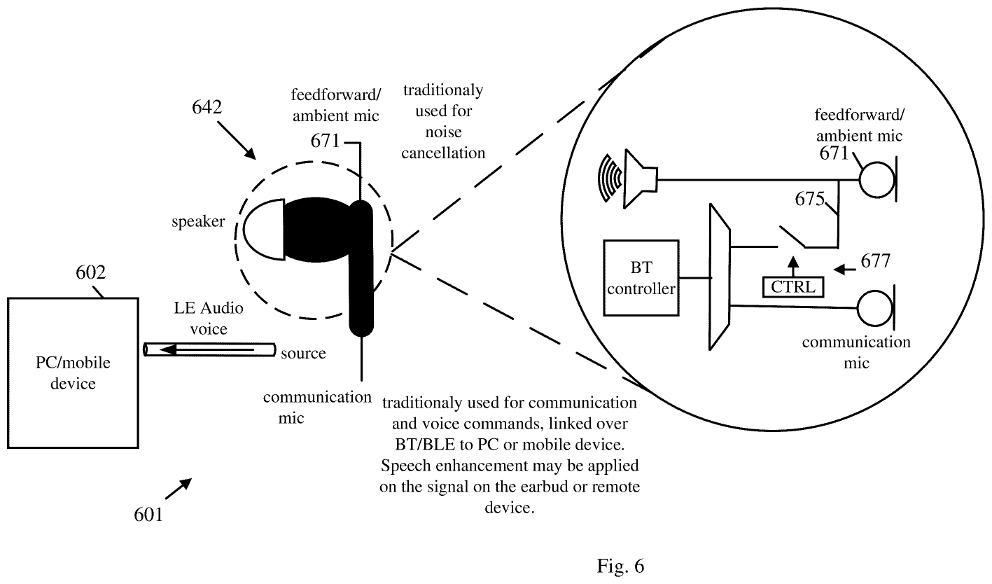

Reference is made to FIG. 6, which schematically illustrates a system 601 including a computing device 602 and an earbud 642 of an audio device, in accordance with some demonstrative aspects. For example, computing device 102 (FIG. 1) may include one or more element of computing device 602, and/or may perform one or more operations and/or functionalities of computing device 602. For example, audio device 140 (FIG. 1) may include one or more element of earbud 642, and/or may perform one or more operations and/or functionalities of earbud 642.

In some demonstrative aspects, computing device 602 may send to the audio device a request to provide ambient sound information based on an output 675 from an ambient microphone 671 of the audio device.

In some demonstrative aspects, the audio device may be configured to provide to the computing device 602 ambient sound information based on the output 675 from the ambient microphone 671.

In some demonstrative aspects, the earbud 642 may include a controlled switch 677, which may be configured to switch the output 675 from the ambient microphone 671 between a first state, e.g., for providing ambient sound information to another device over a BT link, e.g., to the computing device 602; and second state, for providing ambient sound information for noise cancelation at the earbud 642.

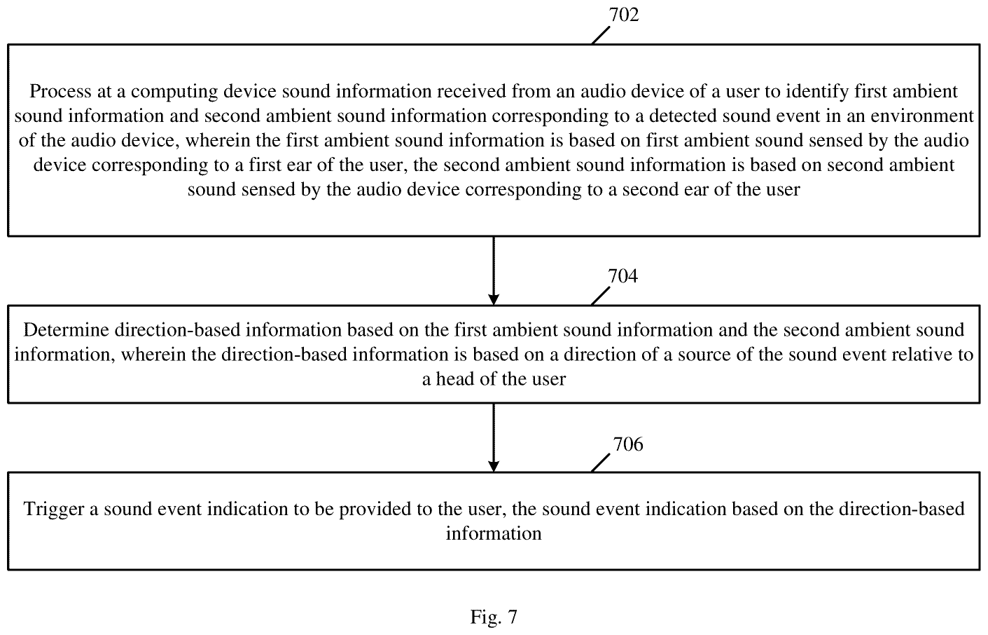

Reference is made to FIG. 7, which schematically illustrates a method of a direction-based sound event indication, in accordance with some demonstrative aspects. For example, one or more of the operations of the method of FIG. 7 may be performed by one or more elements of a system, e.g., system 100 (FIG. 1), for example, a computing device, e.g., computing device 102 (FIG. 1), a controller, e.g., controller 124 (FIG. 1), a radio, e.g., radio 114 (FIG. 1), and/or a message processor, e.g., message processor 128 (FIG. 1) and/or message processor 158 (FIG. 1).

As indicated at block 702, the method may include processing at a computing device sound information received from an audio device of a user to identify first ambient sound information and second ambient sound information corresponding to a detected sound event in an environment of the audio device. For example, the first ambient sound information may be based on first ambient sound sensed by the audio device corresponding to a first ear of the user. For example, the second ambient sound information may be based on second ambient sound sensed by the audio device corresponding to a second ear of the user. For example, controller 124 (FIG. 1) may be configured to cause, trigger, and/or control computing device 102 (FIG. 1) to process the sound information 115 (FIG. 1) received from the audio device 140 (FIG. 1) of the user 160 (FIG. 1), for example, to identify the first ambient sound information and the second ambient sound information corresponding to the detected sound event 152 (FIG. 1) in the environment of the audio device 140 (FIG. 1), e.g., as described above.

As indicated at block 704, the method may include determining direction-based information based on the first ambient sound information and the second ambient sound information. For example, the direction-based information may be based on a direction of a source of the sound event relative to a head of the user. For example, controller 124 (FIG. 1) may be configured to cause, trigger, and/or control computing device 102 (FIG. 1) to determine the direction-based information 125 (FIG. 1), for example, based on the first ambient sound information and the second ambient sound information, e.g., as described above.

As indicated at block 706, the method may include triggering a sound event indication to be provided to the user. For example, the sound event indication may be based on the direction-based information. For example, controller 124 (FIG. 1) may be configured to cause, trigger, and/or control computing device 102 (FIG. 1) to trigger the sound event indication 126 (FIG. 1) to be provided to the user 160 (FIG. 1), e.g., as described above.

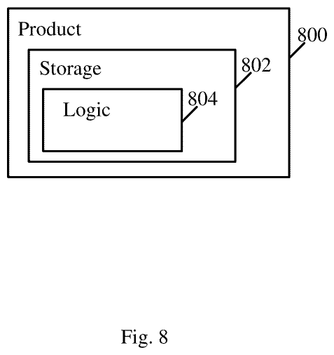

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, and/or 7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine readable storage media 802 may include one or more types of computer-readable storage media capable of storing data, including volatile memory, non-volatile memory, removable or non-removable memory, erasable or non-erasable memory, writeable or re-writeable memory, and the like. For example, machine readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.
Example 1 includes an apparatus comprising logic and circuitry configured to cause a computing device to process sound information received from an audio device of a user to identify first ambient sound information and second ambient sound information corresponding to a detected sound event in an environment of the audio device, wherein the first ambient sound information is based on first ambient sound sensed by the audio device corresponding to a first ear of the user, the second ambient sound information is based on second ambient sound sensed by the audio device corresponding to a second ear of the user; determine direction-based information based on the first ambient sound information and the second ambient sound information, wherein the direction-based information is based on a direction of a source of the sound event relative to a head of the user; and trigger a sound event indication to be provided to the user, the sound event indication based on the direction-based information.
Example 2 includes the subject matter of Example 1, and optionally, wherein the apparatus is configured to cause the computing device to detect the sound event based on acoustic information from at least one acoustic sensor of the computing device.
Example 3 includes the subject matter of Example 2, and optionally, wherein the apparatus is configured to cause the computing device to maintain buffered sound information by buffering the sound information, and, based on detection of the sound event, to trigger processing of the buffered sound information to determine the direction-based information.
Example 4 includes the subject matter of any one of Examples 1-3, and optionally, wherein the apparatus is configured to cause the computing device to detect the sound event based on the sound information received from the audio device.
Example 5 includes the subject matter of any one of Examples 1-4, and optionally, wherein the apparatus is configured to cause the computing device to detect the sound event during an audio streaming of audio content to the audio device.
Example 6 includes the subject matter of Example 5, and optionally, wherein the apparatus is configured to cause the computing device to trigger the sound event indication during the audio streaming of the audio content to the audio device.
Example 7 includes the subject matter of Example 5 or 6, and optionally, wherein the audio streaming of the audio content comprises Bluetooth Low-Energy (LE) audio streaming of the audio content from the computing device to the audio device.
Example 8 includes the subject matter of any one of Examples 1-7, and optionally, wherein the direction-based information comprises Direction of Arrival (DoA) information of an estimated DoA of the sound event relative to the head of the user.
Example 9 includes the subject matter of Example 8, and optionally, wherein the apparatus is configured to cause the computing device to determine the DoA information based on a user-calibrated Head-Related Transfer Function (HRTF) corresponding to the user.
Example 10 includes the subject matter of Example 9, and optionally, wherein the apparatus is configured to cause the computing device to instruct the user to position the head of the user at a plurality of different head positions during a plurality of calibration time periods; emit sound calibration sounds via one or more acoustic transducers of the computing device during the plurality of calibration time periods; and determine the user-calibrated HRTF based on calibration sound information received from the audio device during the plurality of calibration time periods.
Example 11 includes the subject matter of any one of Examples 8-10, and optionally, wherein the apparatus is configured to cause the computing device to determine the DoA information based on a predefined Head-Related Transfer Function (HRTF).
Example 12 includes the subject matter of any one of Examples 1-11, and optionally, wherein the direction-based information comprises Relative Transfer Function (RTF) information corresponding to an RTF between a first channel and a second channel, wherein the first channel is between the first ear and the source of the sound event, and the second channel is between the second ear and the source of the sound event.
Example 13 includes the subject matter of any one of Examples 1-12, and optionally, wherein the apparatus is configured to cause the computing device to trigger the sound event indication by triggering an audio indication to be provided by the audio device to the user.
Example 14 includes the subject matter of any one of Examples 1-12, and optionally, wherein the apparatus is configured to cause the computing device to trigger the sound event indication by triggering a binaural audio indication to be provided by the audio device to the user, wherein the binaural audio indication is configured based on the direction-based information.
Example 15 includes the subject matter of Example 14, and optionally, wherein the apparatus is configured to cause the computing device to configure the binaural audio indication comprising first processed audio to be provided to the first ear of the user and second processed audio to be provided to the second ear of the user, wherein the first processed audio is based on the first ambient sound information and the direction-based information, wherein the second processed audio is based on the second ambient sound information and the direction-based information.
Example 16 includes the subject matter of any one of Examples 1-15, and optionally, wherein the apparatus is configured to cause the computing device to send to the audio device a request to provide the first ambient sound information based on a first output from a first ambient microphone of the audio device, and to provide the second ambient sound information based on a second output from a second ambient microphone of the audio device.
Example 17 includes the subject matter of any one of Examples 1-16, and optionally, wherein the sound event indication comprises a visual indication to be displayed to the user by a display of the computing device.
Example 18 includes the subject matter of any one of Examples 1-17, and optionally, wherein the apparatus is configured to cause the computing device to configure a Bluetooth Low-Energy (LE) Basic Audio Profile (BAP) to communicate the sound information from a BAP audio source comprising the audio device to a BAP audio sink comprising the computing device.
Example 19 includes the subject matter of any one of Examples 1-18, and optionally, wherein the sound event comprises a user-defined event defined for the user.
Example 20 includes the subject matter of any one of Examples 1-19, and optionally, wherein the sound event comprises a predefined spoken term.
Example 21 includes the subject matter of any one of Examples 1-20, and optionally, wherein the audio device comprises earbuds, earphones, or headphones.
Example 22 includes the subject matter of any one of Examples 1-21, and optionally, comprising at least one radio to receive the sound information from the audio device.
Example 23 includes the subject matter of Example 22, and optionally, comprising one or more antennas connected to the radio, and a processor to execute instructions of an operating system.
Example 24 comprises an apparatus comprising means for executing any of the described operations of Examples 1-23.
Example 25 comprises a computing device configured to perform any of the described operations of Examples 1-23.
Example 26 comprises a product comprising one or more tangible computer-readable non-transitory storage media comprising instructions operable to, when executed by at least one processor, enable the at least one processor to cause any of the described operations of Examples 1-23.
Example 27 comprises an apparatus comprising: a memory interface; and processing circuitry configured to: perform any of the described operations of Examples 1-23.
Example 28 comprises a method comprising any of the described operations of Examples 1-23.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a computing device to:
process sound information received from an audio device of a user to identify first ambient sound information and second ambient sound information corresponding to a detected sound event in an environment of the audio device, wherein the first ambient sound information is based on first ambient sound sensed by the audio device corresponding to a first ear of the user, the second ambient sound information is based on second ambient sound sensed by the audio device corresponding to a second ear of the user;
determine direction-based information based on the first ambient sound information and the second ambient sound information, wherein the direction-based information is based on a direction of a source of the sound event relative to a head of the user; and
trigger a sound event indication to be provided to the user, the sound event indication based on the direction-based information.

2. The apparatus of claim 1 configured to cause the computing device to detect the sound event based on acoustic information from at least one acoustic sensor of the computing device.

3. The apparatus of claim 2 configured to cause the computing device to maintain buffered sound information by buffering the sound information, and, based on detection of the sound event, to trigger processing of the buffered sound information to determine the direction-based information.

4. The apparatus of claim 1 configured to cause the computing device to detect the sound event based on the sound information received from the audio device.

5. The apparatus of claim 1 configured to cause the computing device to detect the sound event during an audio streaming of audio content to the audio device.

6. The apparatus of claim 5 configured to cause the computing device to trigger the sound event indication during the audio streaming of the audio content to the audio device.

7. The apparatus of claim 1, wherein the direction-based information comprises Direction of Arrival (DoA) information of an estimated DoA of the sound event relative to the head of the user.

8. The apparatus of claim 7 configured to cause the computing device to determine the DoA information based on a user-calibrated Head-Related Transfer Function (HRTF) corresponding to the user.

9. The apparatus of claim 8 configured to cause the computing device to:
instruct the user to position the head of the user at a plurality of different head positions during a plurality of calibration time periods;
emit sound calibration sounds via one or more acoustic transducers of the computing device during the plurality of calibration time periods; and
determine the user-calibrated HRTF based on calibration sound information received from the audio device during the plurality of calibration time periods.

10. The apparatus of claim 1, wherein the direction-based information comprises Relative Transfer Function (RTF) information corresponding to an RTF between a first channel and a second channel, wherein the first channel is between the first ear and the source of the sound event, and the second channel is between the second ear and the source of the sound event.

11. The apparatus of claim 1 configured to cause the computing device to trigger the sound event indication by triggering an audio indication to be provided by the audio device to the user.

12. The apparatus of claim 1 configured to cause the computing device to trigger the sound event indication by triggering a binaural audio indication to be provided by the audio device to the user, wherein the binaural audio indication is configured based on the direction-based information.

13. The apparatus of claim 12 configured to cause the computing device to configure the binaural audio indication comprising first processed audio to be provided to the first ear of the user and second processed audio to be provided to the second ear of the user, wherein the first processed audio is based on the first ambient sound information and the direction-based information, wherein the second processed audio is based on the second ambient sound information and the direction-based information.

14. The apparatus of claim 1 configured to cause the computing device to send to the audio device a request to provide the first ambient sound information based on a first output from a first ambient microphone of the audio device, and to provide the second ambient sound information based on a second output from a second ambient microphone of the audio device.

15. The apparatus of claim 1 configured to cause the computing device to configure a Bluetooth Low-Energy (LE) Basic Audio Profile (BAP) to communicate the sound information from a BAP audio source comprising the audio device to a BAP audio sink comprising the computing device.

16. The apparatus of claim 1 comprising at least one radio to receive the sound information from the audio device, one or more antennas connected to the radio, and a processor to execute instructions of an operating system.

17. A product comprising one or more tangible computer-readable non-transitory storage media comprising instructions operable to, when executed by at least one processor, enable the at least one processor to cause a computing device to:
process sound information received from an audio device of a user to identify first ambient sound information and second ambient sound information corresponding to a detected sound event in an environment of the audio device, wherein the first ambient sound information is based on first ambient sound sensed by the audio device corresponding to a first ear of the user, the second ambient sound information is based on second ambient sound sensed by the audio device corresponding to a second ear of the user;
determine direction-based information based on the first ambient sound information and the second ambient sound information, wherein the direction-based information is based on a direction of a source of the sound event relative to a head of the user; and
trigger a sound event indication to be provided to the user, the sound event indication based on the direction-based information.

18. The product of claim 17, wherein the instructions, when executed, cause the computing device to detect the sound event based on acoustic information from at least one acoustic sensor of the computing device.

19. The product of claim 18, wherein the instructions, when executed, cause the computing device to maintain buffered sound information by buffering the sound information, and, based on detection of the sound event, to trigger processing of the buffered sound information to determine the direction-based information.

20. The product of claim 17, wherein the instructions, when executed, cause the computing device to trigger the sound event indication by triggering a binaural audio indication to be provided by the audio device to the user, wherein the binaural audio indication is configured based on the direction-based information.
